(19) United States
(12) Patent Application Publication
(10) Pub. No.: US 2008/0175548 A1
(43) Pub. Date: Jul. 24, 2008

(54) Preconnectorized fiber optic cable assembly

(76) Inventors: Dennis Michael Knecht, Hickory, NC (US); Christopher Paul Lewallen, Hudson, NC (US); James Phillip Luther, Hickory, NC (US)

Correspondence Address: CORNING CABLE SYSTEMS LLC, C/O CORNING INC., INTELLECTUAL PROPERTY DEPARTMENT, SP-TI-3-1, CORNING, NY, 14831, US

(21) Appl. No.: 11/656,912

(22) Filed: Jan. 23, 2007

(51) Int. Cl. G02B 6/44

(52) U.S. Cl. 385/100

(57) ABSTRACT

A cable assembly configured to be deployed in a fiber optic communications network includes a pulling grip body disposed at an upstream end of the cable assembly and a preconnectorized distribution cable having a plurality of optical fibers and at least one strength member. The pulling grip body includes a pulling loop that is mechanically coupled to the strength member to permit a high tensile load to be transferred to the distribution cable without inducing relative movement between the cable elements. The pulling grip body is preferably formed by overmolding the pulling loop and the strength member with a flexible encapsulant material. At least one multifiber connector is terminated to optical fibers of the distribution cable at the upstream end. The pulling grip assembly and the preconnectorized distribution cable have a low profile capable of being pulled through a conduit.

### FIELD OF THE INVENTION

The present invention relates to a cable assembly, and more particularly, to a cable assembly for a preconnectorized optical ribbon distribution cable configured to be deployed in a fiber optic communications network.

### BACKGROUND OF THE INVENTION

Optical fiber is increasingly being used to deliver broadband communications, including voice, video and data transmissions, to subscribers over a fiber optic network. Such fiber optic communications networks require a number of connection terminals at which multiple optical fibers are interconnected. Examples of connection terminals include, but are not limited to, optical device enclosures, network access point (NAP) enclosures, aerial closures, below grade closures, pedestals, optical network terminals (ONTs) and network interface devices (NIDs). As illustrated in FIG. 1, a feeder cable 20 having a relatively low number of optical fibers typically interconnects a communications central office (CO) 22 and a connection terminal 24 commonly referred to as a fiber distribution hub (FDH). The optical signals carried on the optical fibers of the feeder cable are distributed (i.e., split) within the FDH 24 into multiple optical signals carried on a corresponding number of distribution optical fibers 25. The optical fibers 25 from the FDH 24 are then interconnected with optical fibers of a primary distribution cable 30 having a relatively high number of optical fibers. The downstream end of the primary distribution cable 30 (i.e., the end of the cable in the direction of the subscribers) may be routed to another connection terminal (not shown) or to a secondary distribution cable 40. As used herein, the term “secondary distribution cable” is intended to include a branch cable, a tether cable or a drop cable having at least one optical fiber.

The secondary distribution cable 40 may have the same number of optical fibers as the primary distribution cable 30, but typically has fewer optical fibers. In the latter instance, optical fibers of the primary distribution cable 30 are “dropped off” or “tapped” at intermediate locations along the length of the cable and interconnected with a connection terminal or other secondary distribution cable. Accordingly, the cable assembly indicated generally by reference numeral 27 and including the primary distribution cable 30 is commonly referred to as the “high fiber count portion of the distribution system.” Similarly, the cable assembly indicated generally by reference numeral 29 and including the secondary distribution cable 40 is commonly referred to as “the low fiber count portion of the distribution system.” As such, it is possible that the optical fibers of a lower fiber count secondary distribution cable 40 may be interconnected with optical fibers tapped from a higher fiber count primary distribution cable 30 at one or more intermediate tap locations 35, as well as at the downstream end of the primary distribution cable. Furthermore, the optical fibers remaining at the downstream end of the higher fiber count primary distribution cable 30 may be interconnected to a connection terminal, as previously mentioned. Likewise, optical fibers tapped from the lower fiber count secondary distribution cable 40 may be interconnected with optical fibers of a connection terminal or other secondary distribution cable (e.g., a drop cable) at intermediate tap locations 45 along the length of the secondary distribution cable.

Regardless, the feeder cable 20, the FDH 24, the primary distribution cable 30, the secondary distribution cable 40 and any additional connection terminals combine to extend fiber optic communications services to a subscriber. In this regard, the fiber optic communications network is operable to deliver “fiber-to-the-curb” (FTTC), “fiber-to-the-business” (FTTB), “fiber-to-the-home” (FTTH) and/or “fiber-to-the-premises” (FTTP), collectively referred to as “FTTx,” broadband communications service. In order to cost effectively and rapidly deploy an FTTx communications network, it is desirable to terminate the optical fibers of the primary distribution cable 30 and the secondary distribution cable 40 to fiber optic connectors in a controlled factory environment. The fiber optic connectors terminated to the distribution cable are typically housed in a connector plug or in a compatible connector jack configured to receive the connector plug. Distribution cables having optical fibers terminated to fiber optic connectors at the factory are referred to herein as “preconnectorized.” Preconnectorized distribution cables permit the optical fibers to be interconnected with optical fibers of other preconnectorized optical cables and to connection terminals without removing the jacket of the distribution cable, and thereby exposing the optical fibers to adverse environmental conditions, such as moisture, dirt or dust. In addition, significant portions of the fiber optic network can be rapidly installed and readily interconnected by a less highly skilled technician in a “plug-and-play” manner. As a result, significant performance and cost advantages are obtained by employing preconnectorized distribution cables configured to be deployed in an FTTx communications network.

However, the use of preconnectorized distribution cables in a fiber optic communications network presents certain challenges. First, a terminated end of the distribution cable oftentimes must be pulled to a desired location, such as to a connection terminal (e.g., an FDH) or to another distribution cable, through a relatively small diameter conduit. Accordingly, it would be desirable for the terminated end of the distribution cable to be provided with a pulling grip assembly (including any furcation elements, connectors, connector plugs and/or connector jacks) that is capable of transferring a high tensile load to the cable without inducing relative movement between the components of the cable. It would also be desirable for the pulling grip assembly to be sufficiently flexible to be routed through shallow bends and relatively sharp turns within the conduit. In addition, the pulling grip assembly and the distribution cable, should maintain a sufficiently low profile to pass through a tubular conduit having a generally circular cross-section with an inner diameter than less than about several inches, and in some examples, less than about 2 inches. Further, the pulling grip assembly should be able to accommodate various connector types (e.g., SC, ST, LC, DC, MTP, MT-RJ and SC-DC), as well as various numbers of connector plugs and/or connector jacks at the terminated end of the distribution cable. Still further, it would eb desirable for the pulling grip assembly and any excess length (i.e., “slack”) at the terminated end of the distribution cable to be configured to permit convenient and space efficient storage in an outdoor cabinet, terminal, pedestal, closure, vault or other buried or above ground enclosure.

### SUMMARY OF THE INVENTION

To achieve the foregoing and other objects, and in accordance with the purposes of the invention as broadly described herein, the present invention provides various embodiments of a cable assembly for a preconnectorized distribution cable configured to be deployed in a fiber optic communications network. The distribution cable has a terminated end and a pulling grip assembly at the upstream end of the cable assembly. The pulling grip assembly is capable of transferring a high tensile load to the distribution cable without inducing relative movement between the cable elements. In the various exemplary embodiments shown and described herein, the pulling grip assembly and the distribution cable have a low profile that permits the upstream end of the cable assembly to be pulled through a conduit having an inner diameter of about a few inches, and in some examples, less than about 2.0 inches, more preferably less than about 1.25 inches. The low profile pulling grip assembly accommodates various connector types and various numbers of connector plugs and/or connector jacks in a configuration that permits convenient and space efficient storage in a buried or other outdoor enclosure.

In one embodiment, the present invention provides a cable assembly for a preconnectorized distribution cable including a plurality of optical fibers and at least one strength member encased within an outer jacket. The distribution cable has at least one connector terminated on optical fiber(s) of the distribution cable adjacent one end. The cable assembly further includes a pulling grip assembly mechanically coupled to the strength member of the distribution cable on the one end having the connector. The pulling grip assembly permits a tensile load generated by a cable pulling force to be applied to the distribution cable without inducing relative movement between the outer jacket and the optical fibers. In one embodiment, the pulling grip assembly includes a pulling grip body having a pulling loop with at least one leg depending therefrom that is mechanically coupled to the strength member of the distribution cable. The pulling grip body may be formed by overmolding the pulling loop and the at least one strength member of the distribution cable within a flexible encapsulating material. The distribution cable may be an optical ribbon distribution cable that does not contain a filling or flooding gel and the optical fibers consist of a ribbon stack disposed between opposed sheets of water-blocking tape encased within the outer jacket. Accordingly, the optical fibers can be readily and rapidly accessed from the distribution cable and terminated to a connector without needing to thoroughly clean gel from the optical fibers.

In another embodiment, the present invention provides a cable assembly configured to be deployed in a fiber optic communication network with an upstream end of the first cable assembly pulled through a conduit having an inner diameter as small as about 2.0 inches, and more preferably, as small as about 1.25 inches. The cable assembly includes a preconnectorized distribution cable having a plurality of optical fibers and at least one strength member encased within an outer jacket wherein the distribution cable has at least one multifiber connector terminated to optical fibers routed through a tether at the upstream end of the cable assembly. The cable assembly further includes a pulling grip assembly at the upstream end of the cable assembly that is mechanically coupled to the strength member of the distribution cable. The pulling grip assembly and the distribution cable have a low profile that is capable of being pulled through the conduit without the at least one multifiber connector becoming snagged or jammed within the conduit.

In yet another embodiment, the present invention provides a fiber optic communications network including a fiber distribution hub (FDH) having a plurality of preconnectorized optical fibers, a first cable assembly and a second cable assembly. The first cable assembly includes a preconnectorized primary distribution cable and a first pulling grip assembly at an upstream end of the first cable assembly. The first pulling grip assembly is mechanically coupled to the primary distribution cable by a pulling grip body strain relieved to at least one strength member of the primary distribution cable. The preconnectorized primary distribution cable is interconnected with the plurality of preconnectorized optical fibers of the FDH and has at least one intermediate tap location along the length of the cable. The second cable assembly includes a preconnectorized secondary distribution cable and a second pulling grip assembly at an upstream end of the second cable assembly. The second pulling grip assembly is mechanically coupled to the secondary distribution cable by a pulling grip body strain relieved to at least one strength member of the secondary distribution cable. The preconnectorized secondary distribution cable is interconnected with the preconnectorized primary distribution cable at the intermediate tap location. The first pulling grip assembly and the preconnectorized primary distribution cable have a low profile that is capable of being pulled through a conduit having an inner diameter as small as about 1.25 inches, and the second pulling grip assembly and the preconnectorized secondary distribution cable have a low profile have a low profile that is capable of being pulled through a conduit having an inner diameter as small as about 2.0 inches.

Additional features and advantages of the invention will be set forth in the detailed description which follows, and in part will be readily apparent to those skilled in the art from that description or recognized by practicing the invention as described herein, including the detailed description which follows, the claims, as well as the appended drawings. It is to be understood that both the foregoing general description and the following detailed description present exemplary embodiments of the invention, and are intended to provide an overview or framework for understanding the nature and character of the invention as it is claimed.

### BRIEF DESCRIPTION OF THE DRAWINGS

FIG. 1 is a schematic diagram of a portion of a network including embodiments of a first cable assembly and a second cable assembly.

FIG. 2 is a perspective view of the upstream end of the first cable assembly of FIG. 1 showing a first pulling grip assembly for transferring a high tensile load to the distribution cable.

FIG. 3 is a detail plan view of the pulling grip body at the proximal end of the pulling grip assembly of FIG. 2.

FIG. 4 is a detail plan view of a typical intermediate tap body housed within the pulling grip assembly of FIG. 2.

FIG. 5 is a detail plan view of the base tap body at the distal end of the pulling grip assembly of FIG. 2.

FIG. 6 is a perspective view of the upstream end of the second cable assembly of FIG. 1 showing a second pulling grip assembly for transferring a high tensile load to the distribution cable.

FIG. 7 is a perspective view of the pulling grip assembly of FIG. 6 shown with the protective sleeve removed for purposes of clarity.

FIG. 8 is a detail perspective view of the proximal end of a pulling grip assembly prior to forming the pulling grip body.

FIG. 9 is perspective view of an end of an optical ribbon distribution cable for use with a cable assembly.

FIG. 10 is a detail perspective view of an intermediate tap location including an optical ribbon transition element for use with an optical ribbon distribution cable.

FIG. 11 is an enlarged end view showing the low profile of the primary distribution cable and the first pulling grip assembly of FIG. 2 disposed within a tubular conduit.

FIG. 12 is a perspective view of one embodiment for storing and routing the upstream end of the first cable assembly of FIG. 1 to a patch panel.

FIG. 13 is a perspective view of another embodiment for storing and routing the upstream end of the first cable assembly of FIG. 1 to a patch panel.

FIG. 14A is a perspective view of an embodiment for storing and routing the upstream end of the first cable assembly of FIG. 1 to a plurality of preconnectorized optical fibers.

FIG. 14B is a top plan view of the embodiment for storing and routing the upstream end of the first cable assembly of FIG. 1 to a plurality of preconnectorized optical fibers.

### DETAILED DESCRIPTION OF THE INVENTION

Reference will now be made to various embodiments of the invention, examples of which are illustrated in the accompanying drawings figures. Whenever possible, the same reference numerals are used throughout the drawing figures to refer to the same or like parts.

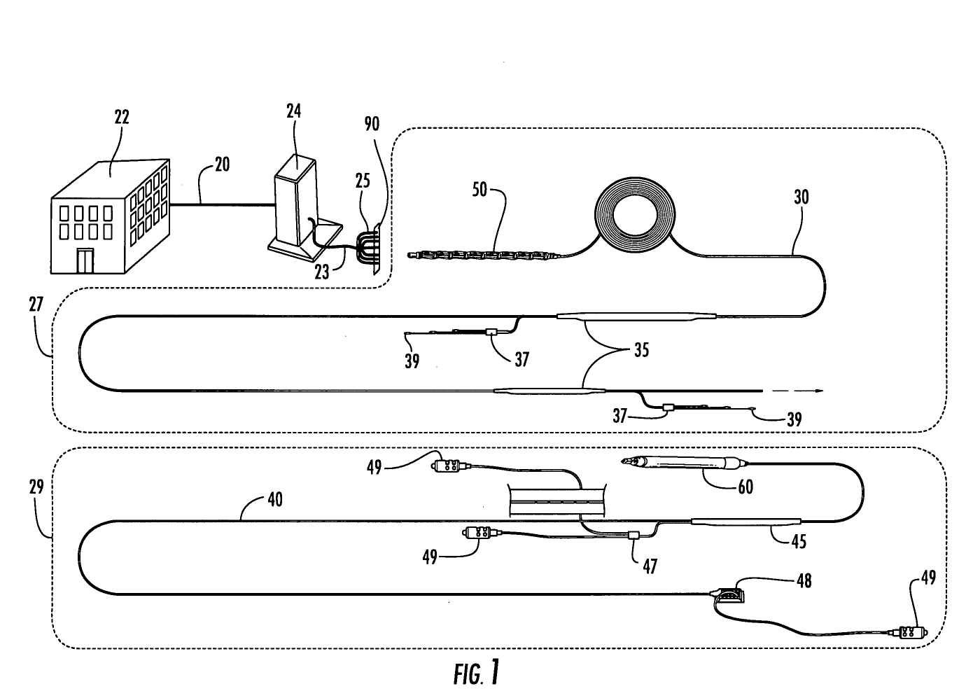

FIG. 1 illustrates a portion of a fiber optic network including a first cable assembly 27 according to the present invention and a second cable assembly 29 according to the present invention. As previously discussed, a feeder cable 20 interconnects a communications central office (CO) 22 with a fiber distribution hub (FDH) 24 in a conventional manner. The first cable assembly 27 includes a primary distribution cable 30 that interconnects the FDH 24 with a secondary distribution cable 40 of the second cable assembly 29. The FDH 24 distributes (e.g., splits) the relatively high power optical signals carried on the optical fibers of the feeder cable 20 into multiple lower power optical signals carried on a plurality of distribution optical fibers 25 in a known manner. The optical fibers 25 may be terminated (i.e., connectorized) by an installer in the field, but preferably are terminated with connectors at the factory (i.e., preconnectorized).

As illustrated in FIG. 1, the optical fibers 25 are bundled together in a protective sheath 23 and routed out of the FDH 24 to be interconnected with the optical fibers of the primary distribution cable 30. For example, the connectorized optical fibers 25 may be routed out the rear of the FDH 24 into a separate enclosure, such as an underground (i.e., buried) vault and interconnected to the optical fibers of the primary distribution cable 30 through a patch panel 90. Alternatively, the optical fibers 25 may be routed from within the FDH 24 to a plurality of fiber optic connectors arranged on a patch panel accessible through the rear of the FDH, or provided on the rear of the FDH. Regardless, it is desirable for the first cable assembly 27 to be preconnectorized so that a less highly skilled technician can rapidly install and readily interconnect the FDH 24 with the primary distribution cable 30 in the well known “plug-and-play” manner. In this regard, the optical fibers of the primary distribution cable 30 are preconnectorized at the upstream end of the cable adjacent the patch panel 90 or adjacent the rear of the FDH 24. Accordingly, the first cable assembly 27 comprises a first pulling grip assembly 50, as will be described in greater detail hereinafter. At intermediate tap locations 35 along the length of the primary distribution cable 30, one or more of the optical fibers are tapped (i.e., severed and removed) from the cable and encased within a protective sheath, such as a buffer tube or transport tube, referred to herein as a “tether.” As shown in FIG. 1, sufficient lengths of the tapped optical fibers are removed from the primary distribution cable 30 and routed collectively to a furcation body 37. The furcation body 37 extracts and separates the optical fibers into two or more subsets of fewer optical fibers encased within a protective sheath, for example a tether. The furcated optical fibers are then terminated to single or multifiber connectors 39 at the factory (i.e., preconnectorized). Each tether, furcation body 37 and connector 39 may be anchored, for example lashed, to the primary distribution cable 30 during installation and deployment until needed.

As also shown in FIG. 1, the optical fibers of the secondary distribution cable 40 may be interconnected with optical fibers of the primary distribution cable 30 at one of the intermediate tap locations 35. Alternatively, the optical fibers of the secondary distribution cable 40 may be interconnected with the optical fibers remaining at the downstream end of the primary distribution cable 30. Furthermore, the optical fibers of a secondary distribution cable 40 may be interconnected with optical fibers of the primary distribution cable 30 at more than one of the intermediate tap locations 35, or at one or more of the intermediate tap locations and at the downstream end of the cable. Regardless, it is desirable for the second cable assembly 29 to also be preconnectorized for readily interconnecting the primary distribution cable 30 with the secondary distribution cable 40 in the well known “plug-and-play” manner. In this regard, the optical fibers of the secondary distribution cable 40 are preconnectorized at the upstream end of the cable adjacent the desired tap location 35 or adjacent the end of the primary distribution cable. Accordingly, the second cable assembly 29 comprises a second pulling grip assembly 60, as will be described in greater detail hereinafter. At intermediate tap locations 45 along the length of the secondary distribution cable 40, one or more of the optical fibers are tapped from the cable and encased within a tether. Sufficient lengths of the tapped optical fibers are removed from the secondary distribution cable 40 and routed collectively to a furcation body 47. The furcation body 47 extracts and separates the optical fibers into two or more subsets of fewer optical fibers encased within a tether. The furcated optical fibers are then terminated to single or multifiber connectors housed within a robust outdoor enclosure 49. The enclosure 49 may comprise a plurality of ports therethrough for receiving a connector plug or a connector jack. A suitable enclosure 49 is the “multiport” enclosure commercially available from Corning Cable Systems LLC of Hickory, N.C. As illustrated in FIG. 1, a first tether is routed from a furcation body 47 to a four-port multiport enclosure 49 on the same side of a road, while a second tether is routed from the furcation body 47 under the road to another four-port multiport enclosure 49 on the other side of the road. The secondary distribution cable 40 may comprise more than one intermediate tap location 45 and may include a final tap location and/or furcation body 47 at the downstream end of the cable. Alternatively, the remaining optical fibers of the secondary distribution cable 40 may be terminated directly to a connection terminal 48 comprising a plurality of ports therethrough for receiving a preconnectorized tether extending from a multiport enclosure 49, as shown in FIG. 1.

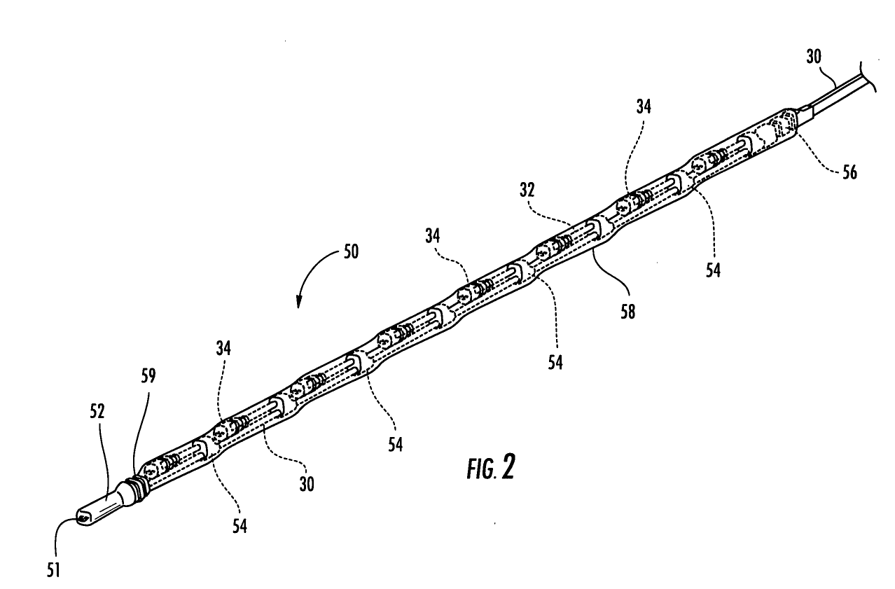

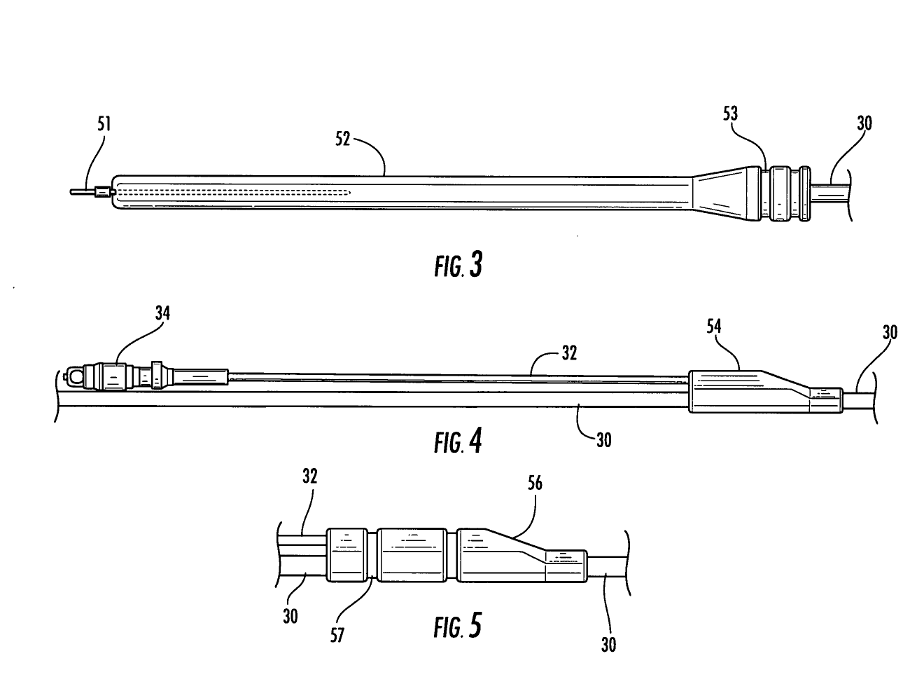

Referring to FIGS. 2-5, the first pulling grip assembly 50 at the upstream end of the first cable assembly 27 is shown in FIG. 2. The pulling grip assembly 50 protects a plurality of connector plugs and/or connector jacks 34 terminated to the optical fibers of the primary distribution cable 30 at the upstream end of the first cable assembly 27. As shown, the first pulling grip assembly 50 comprises a pulling grip body 52 disposed at the proximal end of the assembly and a base tap body 56 disposed at the distal end of the assembly. The pulling grip assembly 50 further comprises a series of intermediate tap bodies 54 disposed medially between the base tap body 56 and the pulling grip body 52. A detail plan view of the pulling grip body 52 located at the proximal end of the pulling grip assembly 50 is shown in FIG. 3. A detail plan view of a typical intermediate tap body 54 housed medially within the pulling grip assembly 50 is shown in FIG. 4. A detail plan view of the base tap body 56 located at the distal end of the pulling grip assembly 50 is shown in FIG. 5. The intermediate tap bodies 54 and the connector plugs and/or connector jacks 34 are contained within a protective sleeve 58 (FIG. 2) that permits the first pulling grip assembly 50 to be pulled through a relatively small diameter conduit without the connector plugs and/or connector jacks 34 becoming snagged or jammed within the conduit. The protective sleeve 58 may be made of a woven fabric material, such as a woven nylon mesh that is fairly elastic and highly resistant to penetration. The material need not be watertight since the pulling grip body 52, the intermediate tap bodies 54 and the base tap body 56 are sealed around the primary distribution cable 30, as will be explained. The protective sleeve 58 is positioned over the pulling grip assembly 50 with its opposite ends secured to the pulling grip body 52 and the base tap body 56 in any suitable manner. As shown herein, one end of the protective sleeve 58 is positioned over one or more grooves 53 provided adjacent the distal end of the pulling grip body 52, while the other end is positioned over one or more grooves 57 provided adjacent the proximal end of the base tap body 56. The protective sleeve 58 is then secured within the grooves 53, 57 by conventional means 59 (FIG. 2), such as straps, clamps, cable ties, etc.

The base tap body 56 and each of the intermediate tap bodies 54 of the pulling grip assembly 50 comprise a tether 32 for routing a plurality of the optical fibers of the primary distribution cable 30 to a connector plug or connector jack 34. The pulling grip assembly 50, including the large number of connector plugs and/or connector jacks 34, provides a low profile cross-section for the preconnectorized primary distribution cable 30 to be pulled through a conduit having an inner diameter as small as about 2.0 inches, and more preferably, as small as about 1.25 inches. In particular, the base tap body 56 and each of the intermediate tap bodies 54 utilize an “express fiber” concept wherein a subset of the optical fibers of the primary distribution cable 30 are tapped (i.e., severed and removed) from the cable, and then routed to a connector plug or connector jack 34 through a tether 32, while the remaining optical fibers of the cable are expressed (i.e., continue) in the direction of the proximal end of the pulling grip assembly 50 (i.e., the upstream end of the first cable assembly 27) to the next intermediate tap body 54. Ultimately, the primary distribution cable 30 is secured (i.e., strain relieved) to the pulling grip body 52 in a suitable manner. An embodiment for strain relieving the primary distribution cable 30 to the pulling grip body 52 of the first pulling grip assembly 50 will be described in greater detail hereinafter. As a result, the first pulling grip assembly 50 transfers a high tensile load from a cable pulling force, for example as much as about 600 lbs., to the primary distribution cable 30 without inducing relative movement between the components of the cable. Thus, the optical fibers of distribution cable 30 can be preconnectorized at the upstream end of the first cable assembly 27 and pulled utilizing a pulling loop 51 provided on the pulling grip body 52 through a conduit to the FDH 24 to be interconnected with the optical fibers 25. As previously mentioned, the optical fibers 25 are preferably terminated to connectors in the factory such that the FDH 24 is also preconnectorized. In a particular example, the primary distribution cable 30 contains 96 optical fibers and the pulling grip assembly 50 comprises a base tap body 56 and seven intermediate tap bodies 54. At the base tap body 56 and at each of the subsequent intermediate tap bodies 54, 12 of the optical fibers of the primary distribution cable 30 are tapped from the cable, and then routed through the corresponding tether 32 to a connector plug or connector jack 34. Each connector plug or connector jack 34 comprises a multifiber connector configured to terminate at least 12 optical fibers. A suitable multifiber connector is the MT style fiber optic connector available from Corning Cable Systems LLC of Hickory, N.C.

The pulling grip body 52, the intermediate tap bodies 54 and the base tap body 56 may be made of any sufficiently flexible material that forms a suitable watertight seal around the primary distribution cable 30 and, in the case of the base tap body and the intermediate tap bodies, around the corresponding tether 32. The pulling grip body 52, the intermediate tap bodies 54 and the base tap body 56 may be ovemolded using a flexible encapsulant material as described in U.S. patent application Ser. No. 10/852,427 filed May 24, 2004, and published as U.S. Patent App. Pub. No. 2005/0259928 on Nov. 24, 2005, which is assigned to the assignee of the present invention and the content of which is incorporated herein in its entirety. As described therein, the overmolding process involves preparing the outer jacket of the primary distribution cable 30 in a manner known in the art, such as by cleaning and roughening, flame preparing or chemically preparing the surface of the outer jacket. The upstream end of the first cable assembly 27, including the first pulling grip assembly 50 and the primary distribution cable 30, is placed into a cavity defined by an overmolding tool and the flexible, encapsulant material is injected into the cavity. Materials suitable for overmolding include, but are not limited to, polyurethane, urethane, silicone and like materials, and may include flame retardant additives or coupounds. The overmolded pulling grip body 52, intermediate tap bodies 54 and base tap body 56 provide an outer protective shell that maintains sealing integrity and is capable of withstanding crush forces up to at least about 300 lbs. The entire overmolded pulling grip assembly 50 and primary distribution cable 30 at the upstream end of the first cable assembly 27 is up to about 20 feet in length and is sufficiently flexible to permit the distribution cable assembly to be deployed through relatively shallow bends and sharps turns within conduit. The degree of flexibility is dependent upon the material chosen and the geometry of the underlying components. Furthermore, each overmolded body 52, 54, 56 of the pulling grip assembly 50 may have a preferential bend in the same direction as a preferential bend of the primary distribution cable 30 or tether 32. In an alternative embodiment, the shape of the overmolded body 52, 54, 56 may force the pulling grip assembly 50 and the primary distribution cable 30 to bend along a preferred axis. In all embodiments, the overmolded body 52, 54, 56 may have any desired shape, however, the preferred shape is both low profile and has rounded or tapered ends so as to avoid becoming snagged or jammed as the upstream end of the first cable assembly 27 is pulled through the conduit during deployment of the preconnectorized primary distribution cable 30.

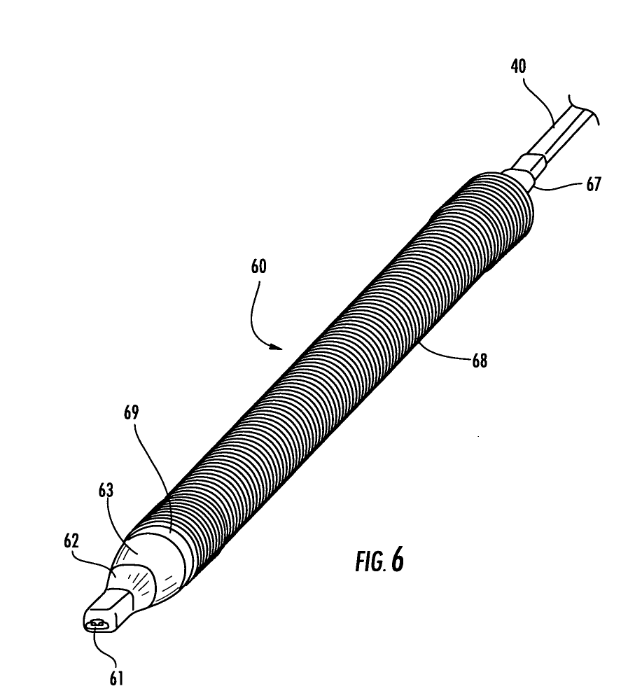

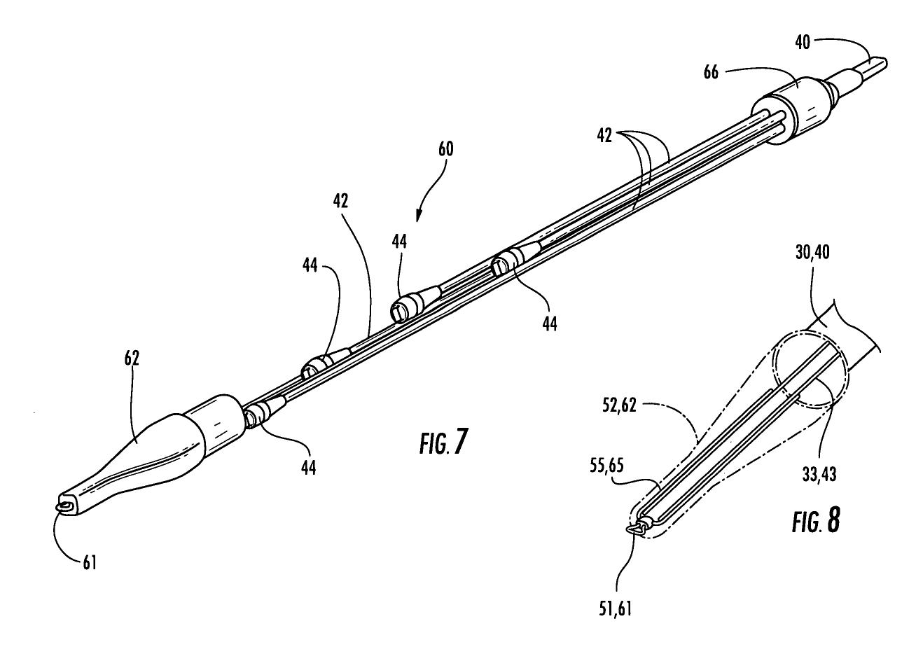

Referring to FIGS. 6-7, the second pulling grip assembly 60 at the upstream end of the second cable assembly 29 is shown in FIG. 6. The pulling grip assembly 60 protects a plurality of connector plugs and/or connector jacks 44 terminated to the optical fibers of the secondary distribution cable 40 at the upstream end of the second cable assembly 29. As best shown in FIG. 7, the second pulling grip assembly 60 comprises a pulling grip body 62 disposed at the proximal end of the assembly and a furcation body 66 disposed at the distal end of the assembly. The pulling grip assembly 60 further comprises a plurality of tethers 42 extending from the furcation body 66 in the direction of the pulling grip body 62. Each of the tethers 42 routes a plurality of optical fibers of the secondary distribution cable 40 to a connector plug and/or connector jack 44 disposed between the furcation body 66 and the pulling grip body 62. The tethers 42 and the connector plugs and/or connector jacks 44 are contained within a protective sleeve 68 that permits the second pulling grip assembly 60 to be pulled through a relatively small diameter conduit without the connector plugs and/or connector jacks 44 becoming snagged or jammed within the conduit. A perspective view of the pulling grip assembly 60 is shown in FIG. 7 with the protective sleeve 68 removed for purposes of clarity. The protective sleeve 68 may be made of a flexible material that is fairly elastic and highly resistant to penetration. However, the material of the protective sleeve 68 need not be watertight since the pulling grip body 62 and the furcation body 66 are overmolded, as previously described, around the secondary distribution cable 40 and the tethers 44. For example, the protective sleeve 68 may be made of a woven fabric material, but more preferably, is made of crush resistant tubing, such as crush resistant PVC or stainless steel reinforced plastic tubing, among others. Regardless, the protective sleeve 68 is positioned over the pulling grip assembly 60 with its opposite ends secured to the pulling grip body 62 and the furcation body 66 in any suitable manner. As shown herein, one end of the protective sleeve 68 is positioned over the distal end of the pulling grip body 62 and secured thereto by a conventional heat deformable (i.e., heat shrink) material 63, while the other end is positioned over the proximal end of the furcation body 66 and secured by a heat deformable (i.e., heat shrink) material 67. If desired, the protective sleeve 68 may be further secured at one or both ends by conventional means 69 (FIG. 6), such as straps, clamps, cable ties, etc.

The pulling grip assembly 60, including the pulling grip body 62, the furcation body 66, the tethers 42 and the fairly large number of connector plugs and/or connector jacks 44, provides a low profile cross-section for the preconnectorized secondary distribution cable 40 to be pulled through a conduit having an inner diameter as small as about 2.0 inches. In particular, the optical fibers of the secondary distribution cable 40 are furcated (i.e., extracted and separated) by the furcation body 66 into multiple subsets of optical fibers, and then each subset of optical fibers is routed to a connector plug or connector jack 44 through a tether 42. Ultimately, the secondary distribution cable 40 is secured (i.e., strain relieved) to the pulling grip body 62 in a suitable manner. A preferred embodiment for strain relieving the secondary distribution cable 40 to the pulling grip body 62 of the second pulling grip assembly 60 will be described in greater detail hereinafter. As a result, the second pulling grip assembly 60 transfers a high tensile load from a cable pulling force, for example as much as about 600 lbs., to the secondary distribution cable 40 without inducing relative movement between the components of the cable. Thus, the optical fibers of the secondary distribution cable 40 (which typically has a lower fiber count than the primary distribution cable 30) can be preconnectorized at the upstream end of the second cable assembly 29 and pulled utilizing a pulling loop 61 provided on the pulling grip body 62 through a conduit to an intermediate tap location 35 to be interconnected with optical fibers tapped from the primary distribution cable 30. As previously mentioned, the optical fibers tapped from the primary distribution cable 30 at the intermediate tap location 35 are preferably terminated to connectors in the factory (i.e., preconnectorized) such that the connector plugs and/or connector jacks 34 can be readily interconnected with the connector plugs and/or connector jacks 44 of the secondary distribution cable 40. In a particular example, the secondary distribution cable 40 contains 48 optical fibers and the pulling grip assembly 60 comprises a furcation body 66 that extracts and separates the optical fibers into four tethers 42. Each tether 42 routes a subset of 12 of the optical fibers of the secondary distribution cable 40 to a connector plug or connector jack 44. Preferably, each connector plug or connector jack 44 comprises a multifiber connector configured to terminate at least 12 optical fibers. A suitable multifiber connector is the MT style fiber optic connector available from Corning Cable Systems LLC of Hickory, N.C.

The pulling grip body 62 and the furcation 66 may be made of any sufficiently flexible material that forms a suitable watertight seal around the secondary distribution cable 40 and, in the case of the furcation body, around the tethers 42. As previously discussed with reference to the first pulling grip assembly 50, the pulling grip body 62 and the furcation body 66 of the second pulling grip assembly 60 are preferably made of a flexible encapsulant material, and more preferably, are overmolded using a polyurethane material in the manner described above. FIG. 8 is a detail perspective view illustrating the proximal end of the pulling grip assembly 50 of the first cable assembly 27 or the proximal end of the pulling grip assembly 60 of the second cable assembly 29 prior to forming the pulling grip body 52, 62, respectively. As previously mentioned, the primary distribution cable 30 extends continuously in the direction of the upstream end of the first cable assembly 27 from the base tap body 56 to the pulling grip body 52. Likewise, the secondary distribution cable 40 may extend continuously in the direction of the upstream end of the second cable assembly 29 from the furcation body 66 to the pulling grip body 62. It should be noted that the optical fibers contained within the primary distribution cable 30 at the upstream end of the first cable assembly 27 will not carry an optical signal (commonly referred to as “dark” optical fibers) since the fibers were tapped from the cable and then routed along tethers 32 to connector plugs and/or connector jacks 34. Similarly, it should be noted that there will be no optical fibers contained within the secondary distribution cable 40 at the upstream end of the second cable assembly 29 since the fibers were furcated from the cable and then routed along tethers 42 to connector plugs and/or connector jacks 44. If desired, the dark optical fibers may be extracted from the upstream end of the first cable assembly 27 so that no optical fibers are contained within the primary distribution cable 30 adjacent the pulling grip body 52.

Regardless, at least one component of the primary distribution cable 30 and the secondary distribution cable 40 extends into the pulling grip body 52, 62, respectively. In a preferred embodiment, a relatively short length of the jacket of the cable 30, 40 extends into the respective pulling grip body 52, 62, while a longer length of one or more strength members 33, 43 of the distribution cable extends further therein. In another preferred embodiment, only the strength members 33, 43 of the distribution cable 30, 40 extend into the respective pulling grip body 52, 62. As shown in FIG. 8, a suitable length of two strength members 33, 43 of the distribution cable 30, 40, respectively, extends into the corresponding pulling grip body 52, 62 sufficiently to overlap a pair of legs 55, 65 depending from a pulling loop 51, 61. The pulling loop 51, 61 is made of a high strength, relatively rigid material, such as hard plastic or metal, that is capable of withstanding a cable pulling force of at least about 600 lbs. and that forms a sufficiently strong mechanical bond with the encapsulant material of the pulling grip body 52, 62. For example, the pulling loop 51, 61 may be made of cast stainless steel. Regardless, the strength members 33, 43 are positioned alongside the legs 55, 65 of the pulling loop 51, 61 as the respective pulling grip body 52, 62 is formed around the strength members and the pulling loop from the flexible encapsulant material using previously described overmolding process. If desired, the strength members 33, 43 of the distribution cable 30, 40 may be secured to the legs 55, 65 of the pulling loop 51, 61 prior to the overmolding process. The strength members 33, 43 may be secured to the legs 55, 65 in any conventional manner, such as by bonding with an adhesive or epoxy, or may be secured by lashing the strength members to the legs utilizing straps, clamps, cable ties, etc.

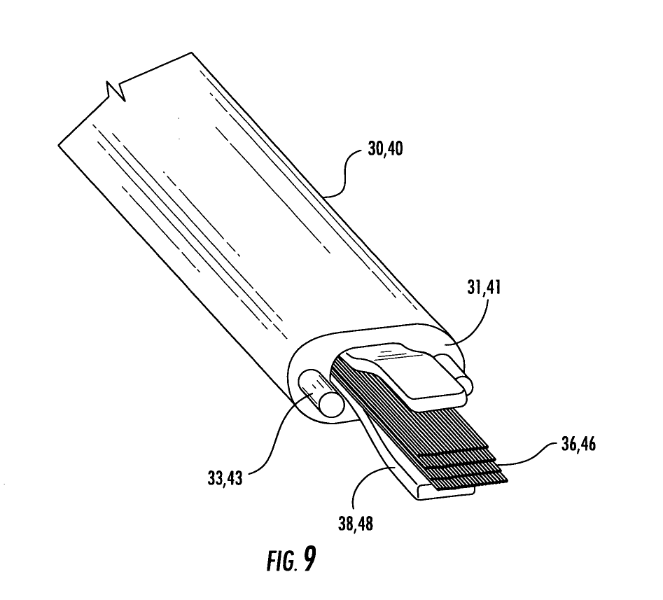

FIG. 9 shows an end of a preferred embodiment of an optical ribbon distribution cable 30, 40 for use with the first cable assembly 27 and the second cable assembly 29, respectively, of the present invention. The optical ribbon distribution cable 30, 40 is particularly well suited for use with the cable assembly 27, 29 since the cable has a “dry” construction (i.e., does not contain gel) and the optical fibers are arranged into a plurality of stacked optical fiber ribbons. A suitable optical ribbon distribution cable 30, 40 is commercially known as RPX™ Gel-Free Ribbon Cable available from Corning Cable Systems LLC of Hickory, N.C. The dry construction of the distribution cable 30, 40 allows optical fibers to be readily tapped (i.e., severed and removed) or furcated (i.e., extracted and separated) from the cable, and then routed into tethers 32, 42 and terminated to connector plugs and/or connector jacks 34, 44 without the need to thoroughly clean gel from the optical fibers. Thus, the time required to manufacture the cable assembly is dramatically reduced and there is less risk of breaking or damaging the optical fibers. The optical ribbons permit the optical fibers to be readily and rapidly terminated to a multifiber connector 34, 44, such as the MT style fiber optic connector available from Corning Cable Systems LLC of Hickory, N.C. As shown, the optical ribbon distribution cable 30, 40 comprises a pair of dielectric strength members 33, 43 and a ribbon stack 36, 46 disposed between opposed sheets of water-blocking tape 38, 48. The strength members 33, 43, the ribbon stack 36, 46 and the water-blocking tapes 38, 48 are encased within a protective outer jacket 31, 41. The strength members 33, 43 provide tensile and anti-buckling strength and are preferably made of a glass reinforced plastic (GRP) material. The ribbon stack 36, 46 comprises a plurality of 24-fiber optical ribbons stacked one on another. Each of the ribbons consists of 24 optical fibers aligned and bound together in a resin matrix that is easily separable by hand into a pair of 12-fiber optical ribbons. In the particular example illustrated in FIG. 9, the ribbon stack 36, 46 comprises four 24-fiber optical ribbons. Thus, the distribution cable shown corresponds to the primary distribution cable 30 containing 96 optical fibers arranged in a ribbon stack 36 consisting of four 24-fiber optical ribbons that are separable by hand into a total of eight 12-fiber optical ribbons available to be terminated to multifiber connector plugs and/or jacks 34 at the upstream end of the first cable assembly 27. The sheets of water-blocking tape 38, 48 are preferably made of a water-swellable foam material that is capable of absorbing any moisture that may penetrate the jacket 31, 41 of the distribution cable 30, 40. The sheets of water-blocking tape 38, 48 also operate to couple the ribbon stack 36, 46 to the jacket 31, 41 to thereby protect the optical fibers from micro-damage caused by S-bending that would otherwise occur during temperature cycling and/or bending of the distribution cable 30, 40. The jacket 31, 41 of the distribution cable 30, 40 is preferably made of a black ultraviolet (UV) resistant polymer material, such as polyethylene.

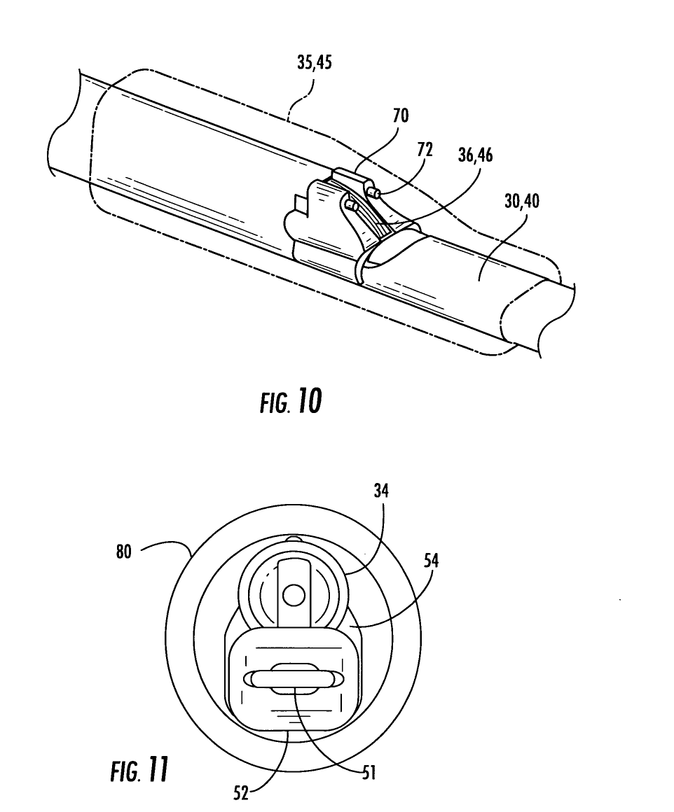

FIG. 10 illustrates a preferred embodiment of a typical intermediate tap location 35, 45 including an optical ribbon transition element 70 for use with an optical ribbon distribution cable 30, 40 in a cable assembly 27, 29 according to the present invention. As previously described, optical fibers of the distribution cable 30, 40 are tapped from the cable at the intermediate tap location 35, 45 and then routed through a tether to a furcation body 37, 47 where the optical fibers are furcated and terminated to multifiber connectors 39, 49. More specifically, certain of the optical fibers are severed (i.e., cut) at a sufficient distance from the tap location 35, 45 in the downstream direction to provide a desired length of the optical fibers outside the distribution cable 30, 40. The severed optical fibers are then removed from the distribution cable 30, 40 through an opening formed at the tap location 35, 45 and routed from the cable to the tether over the optical ribbon transition element 70. The transition element 70 may include a hollow sleeve or tube for encasing and directing the optical fibers into the tether. Alternatively, the transition element may include openings for receiving a short length of the strength members 72 of the tether. A relatively short length of the tether is then aligned with and secured, for example lashed using straps, clamps or cable ties, to the distribution cable 30, 40 and the tap location 35, 45 is formed from the encapsulant material using the overmolding process previously described. If provided, the sleeve or tube of the transition element 70 also operates to protect the optical fibers during the assembly and overmolding process. The distribution cables 30, 40 shown are optical ribbon distribution cable of the type illustrated in FIG. 9 and described above. Accordingly, one or more of the 24-fiber optical ribbons 36, 46 may be tapped from the distribution cable 30, 40 and readily routed over the transition element 70 through the tether to the furcation body 37, 47 in a convenient manner. Alternatively, one or more 12-fiber optical ribbons separated from the 24-fiber optical ribbons 36, 46 may be tapped from the distribution cable 30, 40 and readily routed over the transition element 70. Regardless, one or optical fiber ribbons having at least 12 optical fibers is made available at the furcation body 37, 47 to be terminated to one or more multifiber connectors 39, 49, such as the MT style fiber optic connector available from Corning Cable Systems LLC of Hickory, N.C. It should be noted that the transition element 70 may likewise be utilized with the base tap body 56 and the intermediate tap bodies 54 previously described to transition the optical fibers at the upstream end of the first cable assembly 27 from the primary distribution cable 30 into a tether 32 to be terminated to a connector plug or connector jack 34.

FIG. 11 is an end view illustrating the low profile of the primary distribution cable 30 and the first pulling grip assembly 50 of FIG. 2 disposed within a tubular conduit 80. As previously mentioned, the pulling loop 51 on the pulling grip body 52 of the first pulling grip assembly 50 is used to pull the upstream end of the first cable assembly 27 to the location of the FDH 24. In an exemplary embodiment, the upstream end of the first cable assembly 27 is pulled through the conduit 80 to an interconnect panel, commonly referred to as a “patch panel,” disposed in an underground (i.e., buried) vault or other outdoor enclosure. The primary distribution cable 30 and the pulling grip assembly 50, including the pulling grip body 52, at least one intermediate tap body 54 having a tether 32 and a connector plug or connector jack 34, the base tap body 56 having a tether 32 and a connector plug or connector jack 34 and the protective sleeve 58 (not shown for purposes of clarity), provide a low profile cross-section for the first cable assembly 27 to be pulled through the conduit 80 without the connector plugs and/or connector jacks 34 becoming snagged or jammed within the conduit. Preferably, the conduit 80 has an inner diameter as small as about 2.0 inches, and more preferably, as small as about 1.25 inches. Use of an optical ribbon distribution cable, such as the RPX™ Gel-Free Ribbon Cable available from Corning Cable Systems LLC of Hickory, N.C., previously described, permits the first cable assembly 27 to be pulled through a conduit 80 having an inner diameter as small as about 1.25 inches since the ribbon stack 36, 46 comprises a relatively small number (e.g., four) of 24-fiber wide flat optical ribbons contained within an outer jacket 31, 41 having a generally oval or elliptical cross-section. The RPX™ Gel-Free Ribbon Cable further contributes to the low profile of the first cable assembly 27 (and to the slightly larger profile of the second cable assembly 29) since the primary distribution cable 30 is dry, and therefore does not contain a filling or flooding gel. As a result, the primary distribution cable 30 and the first pulling grip assembly 50 maintain a sufficiently low profile to pass through a tubular conduit 80 having a generally circular cross-section with an inner diameter than less than about 2 inches, and more preferably, less than about 1.25 inches, while being operable to accommodate various connector types (e.g., SC, ST, LC, DC, MTP, MT-RJ and SC-DC), as well as various numbers of connector plugs and/or connector jacks 34 at the upstream end of the first cable assembly 27.

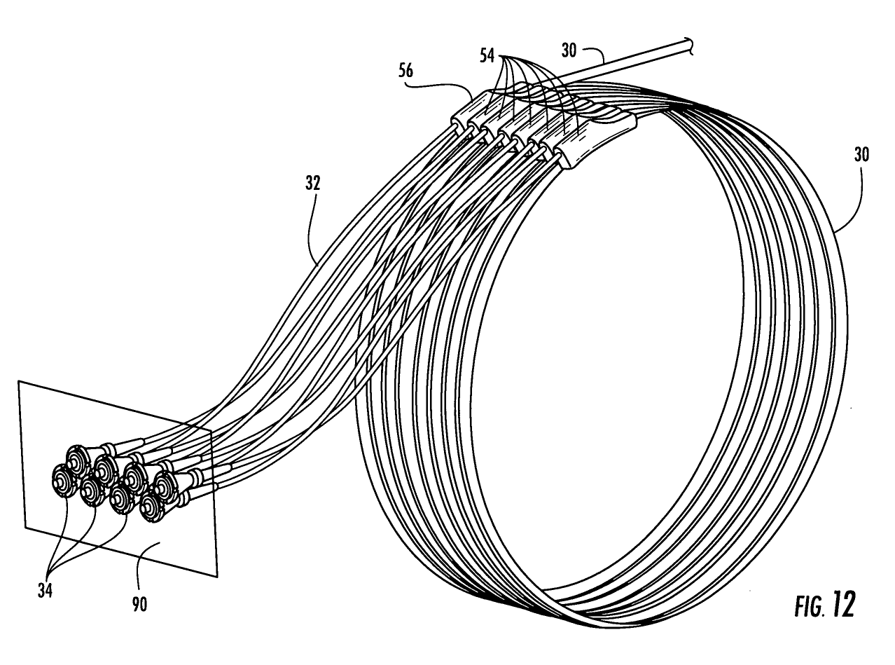

FIGS. 12 and 13 illustrate embodiments of first and second means for storing and routing the upstream end of the first cable assembly 27 of FIG. 1 to a patch panel 90. As previously mentioned, the first cable assembly 27 comprises a first pulling grip assembly 50 for pulling the preconnectorized primary distribution cable 30 through a conduit having an inner diameter as small as about 1.25 inches to a patch panel 90 provided in or on an underground (i.e., buried) vault or other outdoor enclosure. In a preferred embodiment, the patch panel 90 is located adjacent an FDH 24 and the first cable assembly 27 is configured to be deployed in a fiber optic communications network. Once the upstream end of the first cable assembly 27 is pulled to the desired location, the protective sleeve 58 of the pulling grip assembly 50 is removed. The first means for routing and storing the upstream end of the first cable assembly 27 comprises equal lengths of tethers 32 and a predetermined constant distance between the base tap body 56 and each subsequent intermediate tap body 54. Utilizing the first means for storing and routing, the terminated end of the preconnectorized primary distribution cable 30 may be coiled and the tethers 32 routed to the patch panel 90 as shown in FIG. 12. In particular, the terminated end of the primary distribution cable 30 and any desired length of slack cable is coiled around an axis parallel to the plane of the patch panel 90 and the equal length tethers 32 are routed to the patch panel from a common location on the circumference of the coiled cable where the base tap body 56 and the intermediate tap bodies 54 are positioned side-by-side. Conversely, the second means for storing and routing the upstream end of the first cable assembly 27 comprises unequal lengths of tethers 32 and predetermined staggered distances between the base tap body 56 and each subsequent intermediate tap body 54. Utilizing the second means for storing and routing, the terminated end of the preconnectorized primary distribution cable 30 may be coiled and the tethers 32 routed to the patch panel 90 as shown in FIG. 13. In particular, the terminated end of the primary distribution cable 30 and any desired length of slack cable is coiled around an axis parallel to the plane of the patch panel 90 and the unequal length tethers 32 are routed to the patch panel from locations staggered around the circumference of the coiled cable where the base tap body 56 and the intermediate tap bodies 54 are positioned. It should be noted that both the first means and the second means for storing and routing the upstream end of the first cable assembly 27 permits convenient and space efficient storage of the terminated end of the primary distribution cable 30, including the base tap body 56 and the intermediate tap bodies 54 of the first puling grip assembly 50.

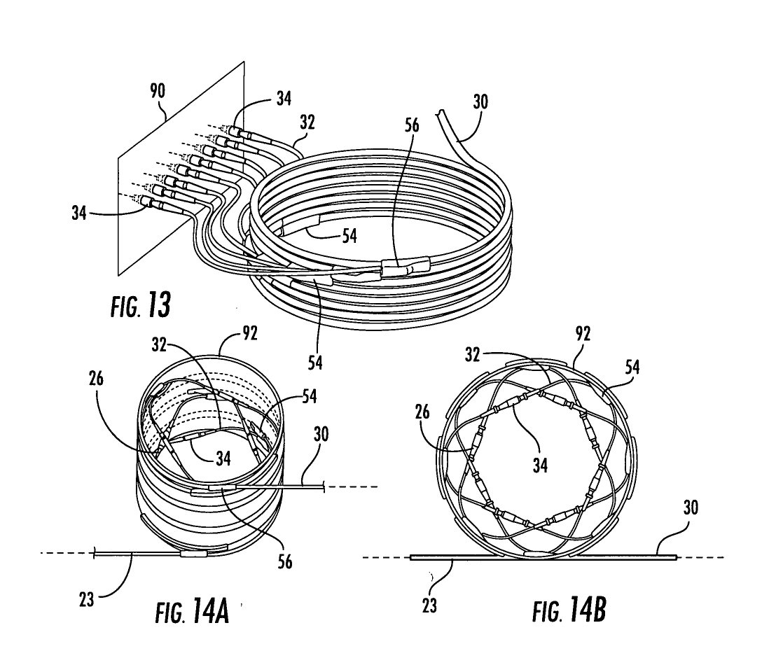

FIGS. 14A and 14B illustrate a means for storing and routing the upstream end of the first cable assembly 27 to a plurality of preconnectorized optical fibers. As previously mentioned, the first cable assembly 27 comprises a first pulling grip assembly 50 for pulling the preconnectorized primary distribution cable 30 through a conduit having an inner diameter as small as about 1.25 inches to an FDH 24. In a preferred embodiment, the FDH 24 is preconnectorized and the first cable assembly 27 is configured to be deployed in a fiber optic communications network. As such, the optical fibers 25 of the FDH 24 are bundled together within a protective sheath or jacket 23 and routed out of the FDH, for example to an underground (i.e., buried) vault or other outdoor enclosure. Furthermore, the ends of the optical fibers 25 are terminated with fiber optic connectors housed within a connector plug and/or connector jack 26 that is compatible with the connector plug and/or connector jack 34 at the terminated end of the primary distribution cable 30. Once the upstream end of the first cable assembly 27 is pulled to the desired location, the protective sleeve 58 of the pulling grip assembly 50 is removed. The means for routing and storing the upstream end of the first cable assembly 27 to a plurality of preconnectorized optical fibers comprises coiling the terminated end of the primary distribution cable 30 and any desired length of slack cable around a canister 92 having openings for passing the base tap body 56 and each subsequent intermediate tap bodies 54 into the interior of the canister. Utilizing the storage and routing means, the terminated end of the preconnectorized primary distribution cable 30 may be coiled and the tethers 32 routed to the interior of the canister 92 as best shown in FIG. 14B. In particular, the terminated end of the primary distribution cable 30 and any desired length of slack cable is coiled around the axis of the canister 92 and the equal or unequal length tethers 32 are routed to the interior of the canister from various locations on the circumference of the canister where the base tap body 56 and the intermediate tap bodies 54 are positioned. Likewise, the optical fibers 25 terminated with a connector plug or connector jack 26 is routed to the interior of the canister 92. The connector plugs and/or connector jacks 34 of the primary distribution cable 30 are then interconnected with the desired connector plugs and/or connector jacks 26 terminated to the optical fibers 25 of the FDH 24. It should be noted that the means for storing and routing the upstream end of the first cable assembly 27 to the plurality of preconnectorized optical fibers 25 permits convenient and space efficient storage of the terminated end of the primary distribution cable 30, including the base tap body 56 and the intermediate tap bodies 54 of the first puling grip assembly 50.

In the various embodiments described herein, the present invention provides a cable assembly 27, 29 for a preconnectorized distribution cable 30, 40 configured to be deployed in a fiber optic communications network that includes a terminated end having a low profile pulling grip assembly 50, 60 capable of transferring a high tensile load to the distribution cable without inducing relative movement between the cable elements. The low profile pulling grip assembly 50, 60 effectively transfers the tensile load generated by the cable pulling force while accommodating various connector types (e.g., MT) and various numbers of connector plugs and/or connector jacks 34, 44 in a configuration that permits convenient and space efficient storage in a buried or above ground enclosure.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A cable assembly comprising:
a distribution cable having a plurality of optical fibers within an outer jacket;
at least one connector terminated on ends of pre-selected optical fibers of the plurality of optical fibers and positioned adjacent one end of the cable; and
at least one tap location positioned along the distribution cable.

2. A cable assembly according to claim 1, further comprising a pulling grip assembly functionally coupled to at least one strength member of the distribution cable on the one end having the at least one connector, the pulling grip assembly being operable to transfer a tensile load generated by a cable pulling force to the distribution cable through the at least one strength member.

3. A cable assembly according to claim 2, wherein the pulling grip assembly comprises a pulling grip body having a pulling loop and wherein the pulling loop is mechanically coupled to the at least one strength member of the distribution cable.

4. A cable assembly according to claim 3, wherein the pulling grip body is formed by overmolding a flexible encapsulant material around the pulling loop and the at least one strength member of the distribution cable.

5. A cable assembly comprising:
a preconnectorized distribution cable having a plurality of optical fibers and at least one strength member encased within an outer jacket, the distribution cable having at least one connector terminated on optical fibers of the distribution cable adjacent one end of the cable; and
a pulling grip assembly mechanically coupled to the at least one strength member of the distribution cable on the one end having the at least one connector, the pulling grip assembly being operable to transfer a tensile load generated by a cable pulling force to the distribution cable through the at least one strength member.

6. A cable assembly according to claim 5, wherein the preconnectorized distribution cable further comprises at least one tap location along the distribution cable.

7. A cable assembly according to claim 5, wherein the pulling grip assembly comprises a pulling grip body having a pulling loop and wherein the pulling loop is mechanically coupled to the at least one strength member of the distribution cable.

8. A cable assembly according to claim 7, wherein the pulling grip body is formed by overmolding a flexible encapsulant material around the pulling loop and the at least one strength member of the distribution cable.

9. A cable assembly according to claim 5, wherein the pulling grip assembly comprises:
a pulling grip body disposed at a proximal end of the pulling grip assembly;
a base tap body disposed at a distal end of the pulling grip assembly, and
at least one intermediate tap body disposed medially between the base tap body and the pulling grip body, each intermediate tap body having a tether containing optical fibers of the distribution cable and a connector terminated on the optical fibers.

10. A cable assembly according to claim 9, wherein the one end of the distribution cable is configured to be coiled with the base tap body and a plurality of intermediate tap bodies positioned side-by-side and with the tethers having an equal length such that the connectors are routed about the same distance from the base tap body and the plurality of intermediate tap bodies to a patch panel.

11. A cable assembly according to claim 9, wherein the one end of the distribution cable is configured to be coiled with the base tap body and a plurality of intermediate tap bodies staggered apart and with the tethers having an unequal length such that the connectors are routed different distances from the base tap body and the plurality of intermediate tap bodies to a patch panel.

12. A cable assembly according to claim 9, wherein the pulling grip body includes a pulling loop mechanically coupled to the at least one strength member of the distribution cable, and the base tap body includes a tether containing optical fibers of the distribution cable and a connector terminated on the optical fibers.

13. A cable assembly according to claim 9, wherein the pulling grip body is formed by overmolding a flexible encapsulant material around the at least one strength member of the distribution cable and wherein the base tap body and the at least one intermediate tap body are formed by overmolding a flexible encapsulant material around the distribution cable and the tether.

14. A cable assembly according to claim 9, further comprising a protective sleeve positioned over the pulling grip body, the base tap body, the at least one intermediate tap body, the tether and the connectors, the protective sleeve having a first end secured to the pulling grip body and a second end secured to the base tap body.

15. A cable assembly according to claim 14, wherein the protective sleeve is a woven fabric material made of a nylon mesh.

16. A cable assembly according to claim 5, wherein the pulling grip assembly comprises:
a pulling grip body disposed at a proximal end of the pulling grip assembly, the pulling grip body having a pulling loop mechanically coupled to the at least one strength member of the distribution cable; and
a furcation body disposed at a distal end of the pulling grip assembly, the furcation body having at least one tether containing optical fibers of the distribution cable and a multifiber connector terminated on the optical fibers.

17. A cable assembly according to claim 16, wherein the pulling grip body is formed by overmolding a flexible encapsulant material around the at least one strength member of the distribution cable and wherein the furcation body is formed by overmolding a flexible encapsulant material around the distribution cable and the at least one tether.

18. A cable assembly according to claim 16, further comprising a protective sleeve positioned over the pulling grip body, the furcation body, the at least one tether and the multifiber connector, the protective sleeve having a first end secured to the pulling grip body and a second end secured to the furcation body.

19. A cable assembly according to claim 5, wherein the pulling grip assembly transfers the tensile load to the distribution cable without inducing relative movement between the outer jacket and the optical fibers.

20. A cable assembly comprising:
a preconnectorized distribution cable having a plurality of optical fibers and at least one strength member encased within an outer jacket, the distribution cable terminating at one end in a plurality of tethers attached about a plurality of tap bodies;
a pulling grip assembly at the one end of the distribution cable coupled to the at least one strength member of the distribution cable; and
at least one tap location along the distribution cable upstream of the one end and including at least one tether.

21. A cable assembly according to claim 20, wherein each of the plurality of tab bodies have a single connectorized tether attached thereto.

22. A fiber optic communications network comprising:
a fiber distribution hub (FDH) having a plurality of preconnectorized optical fibers;
a first cable assembly comprising a preconnectorized primary distribution cable and a first pulling grip assembly at an upstream end of the first cable assembly, the first pulling grip assembly mechanically coupled to the primary distribution cable by a pulling grip body strain relieved to at least one strength member of the primary distribution cable, the preconnectorized primary distribution cable being interconnected with the plurality of preconnectorized optical fibers of the FDH and having at least one intermediate tap location along the length of the primary distribution cable; and
a second cable assembly comprising a preconnectorized secondary distribution cable and a second pulling grip assembly at an upstream end of the second cable assembly, the second pulling grip assembly mechanically coupled to the secondary distribution cable by a pulling grip body strain relieved to at least one strength member of the secondary distribution cable, the preconnectorized secondary distribution cable being interconnected with the preconnectorized primary distribution cable at the intermediate tap location.
